(19) United States
(12) Patent Application Publication
(10) Pub. No.: US 2026/0092570 A1
(43) Pub. Date: Apr. 2, 2026

(54) ENGINE CONTROLLER

(71) Applicant: TOYOTA JIDOSHA KABUSHIKI KAISHA, Toyota-shi (JP)

(72) Inventor: Tatsunobu HATTORI, Seto-shi (JP)

(21) Appl. No.: 19/312,319

(22) Filed: Aug. 28, 2025

(30) Foreign Application Priority Data
Oct. 2, 2024 (JP) 2024-173438

(51) Int. Cl. F02D 41/06; F02D 41/00; F02D 41/38; F02M 21/02

(52) U.S. Cl. CPC F02D 41/062; F02D 41/0027; F02D 41/3845; F02M 21/0242; F02D 2200/503; F02M 21/0206

(57) ABSTRACT

An engine includes a shut-off valve provided in a fuel passage connecting a fuel tank to a fuel injection valve, a starter motor used to start the engine, and a battery for supplying electric power to the shut-off valve and the starter motor. An engine controller includes processing circuitry configured to execute an operation control of the starter motor and an opening-closing control of the shut-off valve. The processing circuitry is configured to execute a control for opening the shut-off valve when a predetermined valve opening condition is satisfied after a start of operation of the starter motor.

### CROSS-REFERENCE TO RELATED APPLICATIONS

This application is based upon and claims the benefit of priority from Japanese Patent Application No. 2024-173438, filed on Oct. 2, 2024, the entire contents of which are incorporated herein by reference.

### BACKGROUND

### 1. Field

The present disclosure relates to an engine controller.

### 2. Description of Related Art

Conventionally, engine control devices are known that control a shut-off valve provided in a fuel passage connecting a fuel tank to a fuel injection valve. The engine controller disclosed in JP2020-56380A closes the shut-off valve while the engine is in a stopped state.

In such engine controllers, the shut-off valve must be opened at the time of engine startup. At this time, depending on the timing of operation of the starter motor of the engine in relation to control for opening the shut-off valve, the engine may fail to start properly.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an engine controller controls an engine including a shut-off valve provided in a fuel passage connecting a fuel tank to a fuel injection valve, a starter motor used to start the engine, and a battery for supplying electric power to the shut-off valve and the starter motor. The engine controller includes processing circuitry configured to execute an operation control of the starter motor and an opening-closing control of the shut-off valve. The processing circuitry is configured to execute a control for opening the shut-off valve when a predetermined valve opening condition is satisfied after a start of operation of the starter motor.

Other features and aspects will be apparent from the following detailed description, the drawings, and the claims.

### BRIEF DESCRIPTION OF THE DRAWINGS

FIG. 1 is a schematic diagram showing a configuration of an engine and an engine controller according to an embodiment.

FIG. 2 is a flowchart showing a start-up process for starting the engine.

FIG. 3 is a timing diagram showing changes in parameters over time when the engine is started, in which part (a) shows activation of a CPU, part (b) shows operation of a starter motor, part (c) shows a first shut-off valve opening request, part (d) shows a second shut-off valve opening request, part (e) shows an engine speed, and part (f) shows a battery voltage.

FIG. 4 is a flowchart showing a start-up process according to a second embodiment.

FIG. 5 is a timing diagram showing changes in parameters over time when the engine is started in the second embodiment and a third embodiment, in which part (a) shows activation of a CPU, part (b) shows operation of a starter motor, part (c) shows a first shut-off valve opening request, part (d) shows a second shut-off valve opening request, part (e) shows an engine speed, and part (f) shows a battery voltage.

FIG. 6 is a flowchart showing a start-up process according to a third embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

### First Embodiment

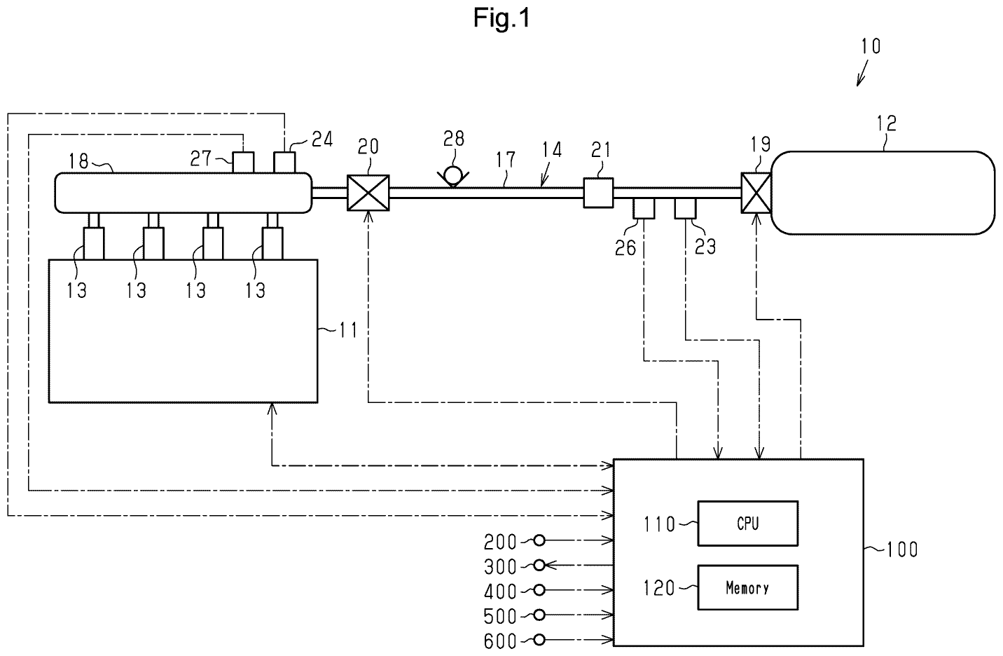

Hereinafter, a first embodiment of an engine controller will be described with reference to FIGS. 1 to 3.

### Engine and Configuration of Engine Controller

An engine 10 shown in FIG. 1 is mounted on a vehicle. The fuel of the engine 10 is gaseous fuel. An example of a gaseous fuel is hydrogen gas.

The engine 10 includes an engine body 11. In FIG. 1, multiple cylinders and multiple spark plugs provided in the engine body 11 are omitted. The engine body 11 burns fuel injected from the multiple fuel injection valves 13 inside the cylinders to thereby generate power for making the vehicle travel.

The engine 10 includes a fuel tank 12, multiple fuel injection valves 13, a fuel passage 14, a first shut-off valve 19, a second shut-off valve 20, a first pressure sensor 23, and a second pressure sensor 24. The fuel tank 12 stores a gaseous fuel. Gaseous fuel is stored in the fuel tank 12 in a compressed state. Gaseous fuel is supplied from the fuel tank 12 to each fuel injection valve 13. Each cylinder is provided with one fuel injection valve 13. The fuel injection valve 13 supplies fuel into the cylinder.

The fuel passage 14 connects the fuel tank 12 and each fuel injection valve 13. The fuel passage 14 is constituted by a fuel pipe 17 connected to the fuel tank 12 and a delivery pipe 18 connecting the fuel pipe 17 and each fuel injection valve 13. The fuel stored in the fuel tank 12 is supplied to each fuel injection valve 13 via a fuel pipe 17 and a delivery pipe 18.

The first shut-off valve 19 and the second shut-off valve 20 are disposed in the fuel passage 14. Each shut-off valve 19, 20 is, for example, an electromagnetic valve. Each shut-off valve 19, 20 is switched between an open state and a closed state by an opening-closing control performed by the controller 100. Each shut-off valve 19, 20 is opened when a valve opening command is received from the controller 100. Each shut-off valve 19, 20 is closed when receiving a valve closing command from the controller 100. Specifically, when a valve opening command is input from the controller 100 to the drive circuit of each shut-off valve 19, 20, the drive circuit supplies electric power to the shut-off valve 19, 20. As a result, the shut-off valve 19, 20 is opened. When a valve closing command is input from the controller 100 to the drive circuit of each shut-off valve 19, 20, the drive circuit stops the supply of electric power to the shut-off valve 19, 20. As a result, the shut-off valve 19, 20 enters a closed state. The first shut-off valve 19 and the second shut-off valve 20 are maintained in an open state during operation of the engine 10. The first shut-off valve 19 and the second shut-off valve 20 are maintained in a closed state while the operation of the engine 10 is stopped.

The first shut-off valve 19 is disposed in the fuel passage 14 in the vicinity of the outlet of the fuel tank 12. The first shut-off valve 19 is disposed at an end portion of the fuel pipe 17 on the fuel tank 12 side. When the first shut-off valve 19 is in an open state, fuel is supplied from the fuel tank 12 to the fuel pipe 17. When the first shut-off valve 19 is in the closed state, the fuel supply from the fuel tank 12 to the fuel pipe 17 is stopped.

The second shut-off valve 20 is disposed downstream of the first shut-off valve 19 in the fuel passage 14. The second shut-off valve 20 is disposed in the fuel pipe 17 at a position close to the delivery pipe 18. When the second shut-off valve 20 is open, fuel is supplied to the delivery pipe 18 through the fuel pipe 17. When the second shut-off valve 20 is in a closed state, fuel supply to the delivery pipe 18 through the fuel pipe 17 is stopped.

A pressure reducing valve 21 is disposed in the fuel passage 14 between the first shut-off valve 19 and the second shut-off valve 20. The pressure reducing valve 21 regulates the pressure of the fuel flowing into the delivery pipe 18 from the high-pressure fuel tank 12.

A relief valve 28 is disposed in the fuel passage 14 between the pressure reducing valve 21 and the second shut-off valve 20. The relief valve 28 discharges the fuel in the fuel pipe 17 to the outside of the fuel pipe 17 when the pressure in the fuel pipe 17 becomes equal to or higher than a certain pressure.

The first pressure sensor 23 and the second pressure sensor 24 detect a passage fuel pressure which is a pressure of the fuel in the fuel passage 14. Each pressure sensor 23, 24 outputs a detection signal related to the detected passage fuel pressure to the controller 100. The first pressure sensor 23 is disposed between the first shut-off valve 19 and the second shut-off valve 20 in the fuel passage 14. The first pressure sensor 23 detects a first passage fuel pressure that indicates a passage fuel pressure between the first shut-off valve 19 and the second shut-off valve 20. The first passage fuel pressure corresponds to the pressure of the fuel in the fuel pipe 17. The second pressure sensor 24 is arranged between the second shut-off valve 20 and the fuel injection valve 13. The second pressure sensor 24 detects a second passage fuel pressure that indicates a passage fuel pressure between the second shut-off valve 20 and the fuel injection valve 13. The second passage fuel pressure corresponds to the pressure of the fuel in the delivery pipe 18.

The engine 10 includes a first temperature sensor 26 and a second temperature sensor 27. Each temperature sensor 26, 27 detects a passage fuel temperature which is a temperature of the fuel in the fuel passage 14. Each temperature sensor 26, 27 outputs a detection signal related to the detected passage fuel temperature to the controller 100.

The first temperature sensor 26 is disposed between the first shut-off valve 19 and the pressure reducing valve 21. The first temperature sensor 26 detects a first passage fuel temperature indicating a passage fuel temperature between the first shut-off valve 19 and the pressure reducing valve 21. The first passage fuel temperature corresponds to the temperature of the fuel in the portion of the fuel pipe 17 upstream of the pressure reducing valve 21. The second temperature sensor 27 is arranged between the second shut-off valve 20 and the fuel injection valve 13. The second temperature sensor 27 detects a second passage fuel temperature indicating a passage fuel temperature between the second shut-off valve 20 and the fuel injection valve 13. The second passage fuel temperature corresponds to the temperature of the fuel in the delivery pipe 18.

The controller 100 performs various types of control of the engine 10 by controlling various control targets including the fuel injection valve 13, the first shut-off valve 19, the second shut-off valve 20, and the pressure reducing valve 21. For example, the controller 100 drives the shut-off valve 19, 20 to open by transmitting a valve opening signal to the shut-off valve 19, 20, and drives the shut-off valve 19, 20 to close by transmitting a valve closing signal to the shut-off valve 19, 20.

The controller 100 includes a memory 120 including a CPU 110, a ROM, and a RAM. When the CPU 110 executes the program stored in the memory 120, various controls are performed by the controller 100. In the present embodiment, the CPU 110 corresponds to processing circuitry.

The controller 100 is connected to a battery 200, a starter motor 300, an ignition switch 400, a coolant temperature sensor 500, and an outside air temperature sensor 600. The starter motor 300 is supplied with electric power from the battery 200 to start the engine 10. When the operation state of the ignition switch 400 is input to the controller 100, the controller 100 detects the presence or absence of a request for starting the engine 10 or a request for stopping the engine 10 by the vehicle driver. That is, when the ignition switch 400 is turned on, the controller 100 determines that there is a request to start the engine 10, and when the ignition switch 400 is turned off, the controller 100 determines that there is a request to stop the engine 10. The coolant temperature sensor 500 detects the temperature of coolant (not shown) for cooling the engine 10. The coolant temperature sensor 500 outputs a detection signal regarding the detected water temperature to the controller 100. The outside air temperature sensor 600 detects the outside air temperature. The outside air temperature sensor 600 outputs a detection signal regarding the detected outside air temperature to the controller 100.

The controller 100 acquires various values necessary for controlling the engine 10. For example, the controller 100 acquires detection signals of the pressure sensor 23, 24, the temperature sensor 26, 27, the ignition switch 400, the coolant temperature sensor 500, and the outside air temperature sensor 600.

### Start-Up Process

The controller 100 executes a start-up process for starting the engine 10. The controller 100 executes the start-up process when the ignition switch 400 is turned on.

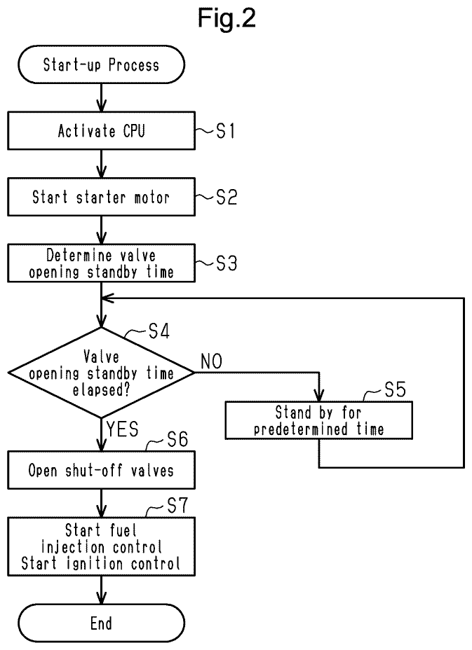

As shown in FIG. 2, in the start-up process, the controller 100 activates the CPU 110 (step S1). Subsequently, the controller 100 performs an operation control to start operation of the starter motor 300 (step S2).

Thereafter, the controller 100 determines a valve opening standby time which is a standby time until the first and second shut-off valves 19 and 20 are opened (step S3). As an example, the controller 100 determines the valve opening standby time in accordance with the passage fuel temperature detected by the temperature sensor 26, 27. Specifically, the controller 100 determines the valve opening standby time in accordance with the passage fuel temperature detected by any one of the temperature sensors 26, 27 and. For example, when the passage fuel temperature is low, the controller 100 determines a longer time as the valve opening standby time than when the passage fuel temperature is high. Further, as an example, the controller 100 determines the valve opening standby time in accordance with the temperature of the coolant detected by the coolant temperature sensor 500. Specifically, when the water temperature of the coolant is low, the controller 100 determines a longer time as the valve opening standby time than when the water temperature of the coolant is high. Further, as an example, the controller 100 determines the valve opening standby time in accordance with the outside air temperature detected by the outside air temperature sensor 600. Specifically, when the outside air temperature is low, the controller 100 determines a longer time as the valve opening standby time than when the outside air temperature is high.

Subsequently, the controller 100 determines whether or not the determined valve opening standby time has elapsed (step S4). If the valve opening standby time has not elapsed (step S4: NO), the controller 100 waits for a predetermined time (step S5), and then returns to the process of step S4. Thus, the controller 100 waits until the valve opening standby time elapses.

If the valve opening standby time has elapsed (step S4: YES), the controller 100 opens the first and second shut-off valves 19 and 20 (step S6). In the present embodiment, the elapse of the valve opening standby time corresponds to the satisfaction of the valve opening condition. That is, the controller 100 opens the first shut-off valve 19 and the second shut-off valve 20 with the establishment of the valve opening condition that the valve opening standby time elapses as a trigger. Thereafter, the controller 100 starts the fuel injection control and the ignition control (step S7), and ends the start-up process.

The fuel injection control is control for controlling each fuel injection valve 13 to inject fuel into each cylinder. The ignition control is control for controlling each spark plug to ignite the air-fuel mixture in each cylinder.

### Operation of the First Embodiment

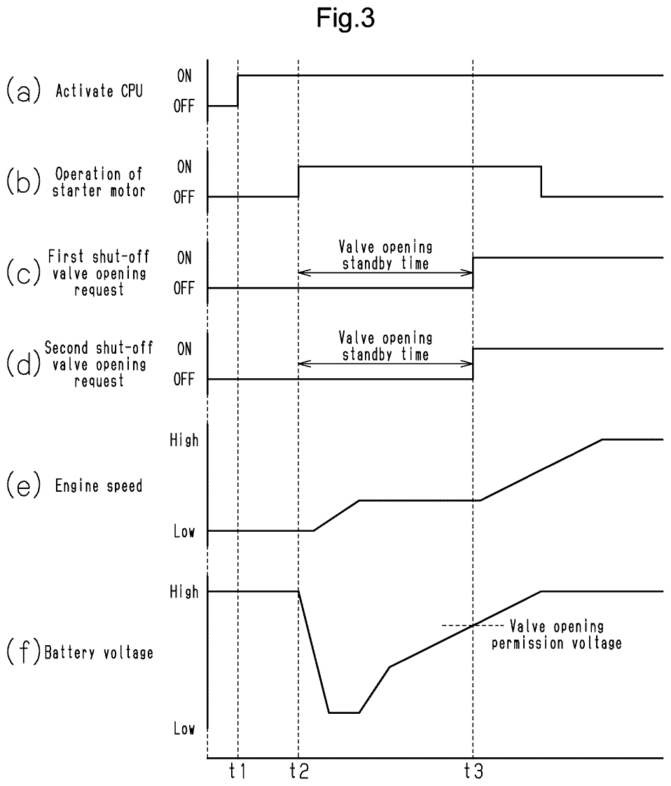

As shown in FIG. 3, in the start-up process described above, the controller 100 starts the operation of the starter motor 300, and then opens the first shut-off valve 19 and the second shut-off valve 20 after the specified valve opening condition is satisfied. In other words, in the present embodiment, the start of the operation of the starter motor 300 is not performed simultaneously with the opening of the first shut-off valve 19 and the second shut-off valve 20.

Specifically, as shown in part (a) of FIG. 3, when the ignition switch 400 is turned on, the CPU 110 is activated (time point t1). As shown in part (b) of FIG. 3, after the CPU 110 is activated, the operation of the starter motor 300 is subsequently started (point in time t2). As a result, as shown in part (e) of FIG. 3, the engine speed starts to increase. At this time, as shown in part (f) of FIG. 3, the voltage of the battery 200 decreases due to the start of the operation of the starter motor 300. Then, as shown in parts (c) and (d) of FIG. 3, the first and second shut-off valves 19 and 20 are opened after the valve opening standby time has elapsed from the start of the operation of the starter motor 300 (point in time t3). During this period, as shown in part (f) of FIG. 3, the voltage of the battery 200, which has decreased due to the start of the operation of the starter motor 300, recovers over time. As a result, in the start-up process, the first shut-off valve 19 and the second shut-off valve 20 are opened after the period during which the voltage of the battery 200 significantly decreases due to the start of operation of the starter motor 300 has passed.

The voltage required to open the first shut-off valve 19 and the second shut-off valve 20 varies depending on the temperature of the engine 10 and the fuel. The controller 100 determines the valve opening standby time in accordance with the detection results of the temperature sensors 26, 27, the coolant temperature sensor 500, and the outside air temperature sensor 600. That is, the controller 100 is capable of determining an appropriate amount of time for recovery of the voltage of the battery 200 in accordance with the temperature of the engine 10 and the fuel.

### Advantages of the First Embodiment

(1-1) In the start-up process, it is possible to prevent the first shut-off valve 19 and the second shut-off valve 20 from being unable to be opened due to the influence of a decrease in the voltage of the battery 200 caused by the start of operation of the starter motor 300. This reduces the likelihood of start-up failure.

(1-2) During the start-up process, a recovery period is ensured between the start of the operation of the starter motor 300 and the opening of the first and second shut-off valves 19 and 20, allowing the voltage of the battery 200 to recover. This enables the first shut-off valve 19 and the second shut-off valve 20 to be opened after the voltage of the battery 200 has begun to rise.

(1-3) During the start-up process, the controller 100 determines a suitable valve opening standby period that allows the voltage of the battery 200 to recover to the level required to open the first and second shut-off valves 19 and 20. As a result, the risk of failure to open the first shut-off valve 19 and the second shut-off valve 20 due to a voltage drop of the battery 200 is further reduced.

### Second Embodiment

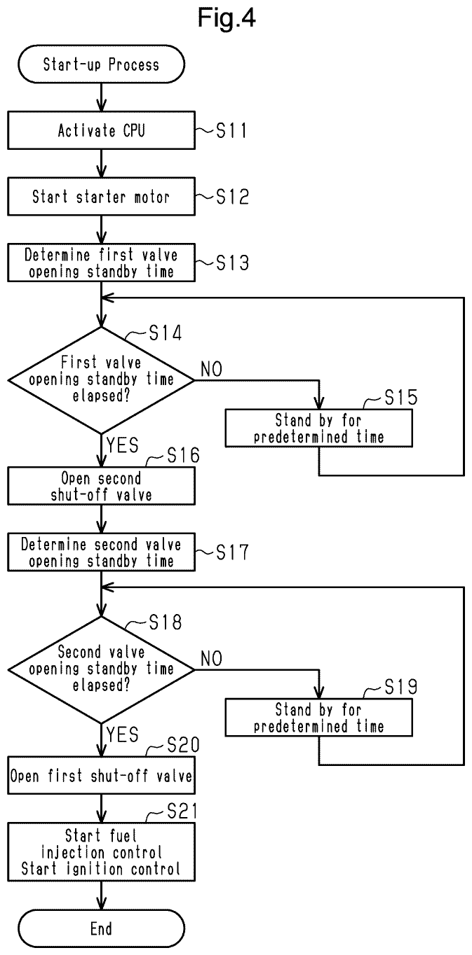

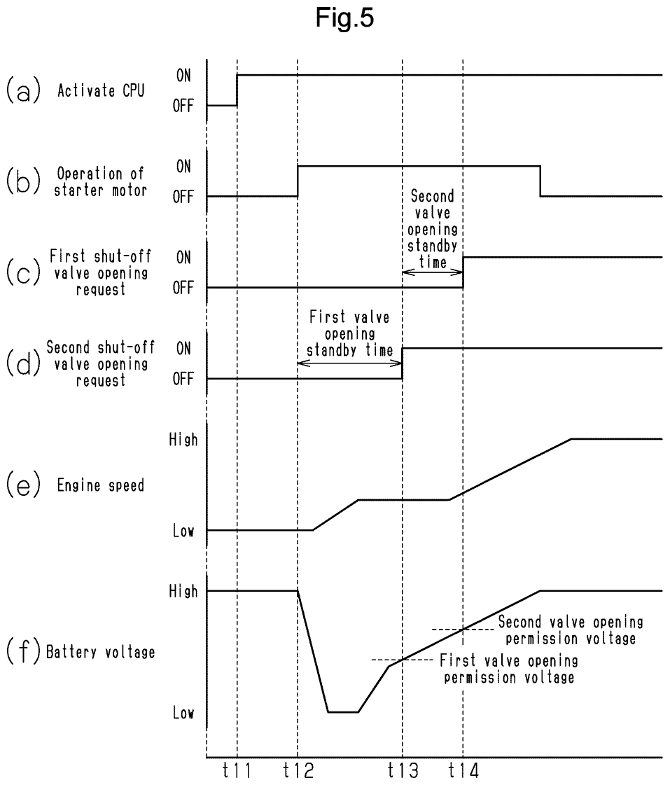

Next, a second embodiment of the engine controller will be described with reference to FIGS. 4 and 5.

### Start-Up Process in Second Embodiment

As shown in FIG. 4, in the start-up process, the controller 100 starts the CPU 110 in the same manner as in the first embodiment (step S11), and starts the operation of the starter motor 300 (step S12).

Thereafter, the controller 100 determines a first valve opening standby time which is a standby time until the second shut-off valve 20 is opened (step S13). In the present embodiment, the first valve opening standby time corresponds to a first standby time. As an example, the controller 100 determines the first valve opening standby time in accordance with the detection results of the temperature sensor 26, 27, the coolant temperature sensor 500, and the outside air temperature sensor 600 in the same manner as when determining the valve opening standby time in the first embodiment.

Subsequently, the controller 100 determines whether or not the determined first valve opening standby time has elapsed (step S14). If the first valve opening standby time has not elapsed (step S14: NO), the controller 100 waits for a certain time (step S15), and then returns to the process of step S14. Thus, the controller 100 waits until the first valve opening standby time elapses. On the other hand, if the first valve opening standby time has elapsed (step S14: YES), the controller 100 opens the second shut-off valve 20 (step S16). After opening the second shut-off valve 20, the controller 100 determines a second valve opening standby time, which is a standby time until the first shut-off valve 19 is opened (step S17). In the present embodiment, the second valve opening standby time corresponds to a second standby time. As an example, the controller 100 determines the second valve opening standby time in accordance with the detection results of the temperature sensor 26, 27, the coolant temperature sensor 500, and the outside air temperature sensor 600 in the same manner as when determining the valve opening standby time in the first embodiment.

Subsequently, the controller 100 determines whether or not the determined second valve opening standby time has elapsed (step S18). When the second valve opening standby time has not elapsed (step S18: NO), the controller 100 waits for a certain time (step S19), and then returns to the process of step S18. Thus, the controller 100 waits until the second valve opening standby time elapses. On the other hand, if the second valve opening standby time has elapsed (step S18: YES), the controller 100 opens the first shut-off valve 19 (step S20). Thereafter, the controller 100 starts the fuel injection control and the ignition control (step S21), and ends the start-up process.

### Operation of the Second Embodiment

As shown in FIG. 5, during the start-up process described above, the controller 100 initiates the operation of the starter motor 300 and subsequently opens the first shut-off valve 19 and the second shut-off valve 20 at different respective timings. In other words, in the present embodiment, the start of the operation of the starter motor 300, the opening of the first shut-off valve 19, and the opening of the second shut-off valve 20 are not performed simultaneously.

Specifically, as shown in part (a) of FIG. 5, when the ignition switch 400 is turned on, the CPU 110 is activated (point in time t11). As shown in part (b) of FIG. 5, after the CPU 110 is activated, the operation of the starter motor 300 is subsequently started (point in time t12). As a result, as shown in part (e) of FIG. 5, the engine speed starts to increase. At this time, as shown in part (f) of FIG. 5, the voltage of the battery 200 decreases due to the start of the operation of the starter motor 300. Then, as shown in part (c) of FIG. 5, the second shut-off valve 20 is opened after the first valve opening standby time has elapsed from the start of the operation of the starter motor 300 (point in time t13). Further, as shown in part (d) of FIG. 5, the first shut-off valve 19 is opened after the second valve opening standby time has elapsed since the second shut-off valve 20 is opened (point in time t14). During this period, as shown in part (f) of FIG. 5, the voltage of the battery 200 recovers over time. Accordingly, during the start-up process, the first shut-off valve 19 and the second shut-off valve 20 are sequentially opened in accordance with recovery of the voltage of the battery 200, which was initially reduced due to the initiation of operation of the starter motor 300.

### Advantages of the Second Embodiment

(2-1) The voltage of the battery 200 required to independently open either the first shut-off valve 19 or the second shut-off valve 20 is lower than the voltage of the battery 200 required to simultaneously open both valves. Therefore, the present embodiment suppresses failure to open the first shut-off valve 19 and the second shut-off valve 20 during the start-up process. This reduces the likelihood of start-up failure.

(2-2) The present embodiment opens the first shut-off valve 19 and the second shut-off valve 20 at separate timings. This sequential control enables both valves 19, 20 to be opened at voltages lower than the voltage required for simultaneous opening. Consequently, the present embodiment reduces the time needed to open the first shut-off valve 19 and the second shut-off valve 20 compared to an operation to simultaneously open the valves 19, 20. This configuration enables the engine 10 to start more promptly.

(2-3) The pressure in the fuel pipe 17 is higher on the upstream side of the pressure reducing valve 21 than on the downstream side of the pressure reducing valve 21. The first shut-off valve 19 is disposed upstream of the pressure reducing valve 21, and the second shut-off valve 20 is disposed downstream of the pressure reducing valve 21. The voltage required to open each of the shut-off valves 19 and 20 increases in proportion to the pressure applied to the respective valves 19, 20. Therefore, the voltage required to open the first shut-off valve 19 is higher than the voltage required to open the second shut-off valve 20. Accordingly, the time required for the voltage of the battery 200 to recover to the level necessary to open the first shut-off valve 19 is longer than the time required for recovery to the level necessary to open the second shut-off valve 20. The present embodiment prioritizes opening of the second shut-off valve 20, which requires the lower voltage, thereby enabling rapid opening of both the first shut-off valve 19 and the second shut-off valve 20.

(2-4) The present embodiment opens the second shut-off valve 20, which is disposed closer to the delivery pipe 18 in the fuel pipe 17, prior to opening the first shut-off valve 19, which is disposed near the outlet of the fuel tank 12. This configuration opens the second shut-off vale 20 to supply fuel remaining in the fuel pipe 17 to the delivery pipe 18 even before the first shut-off valve 19 is opened. As a result, the engine 10 is started promptly.

### Third Embodiment

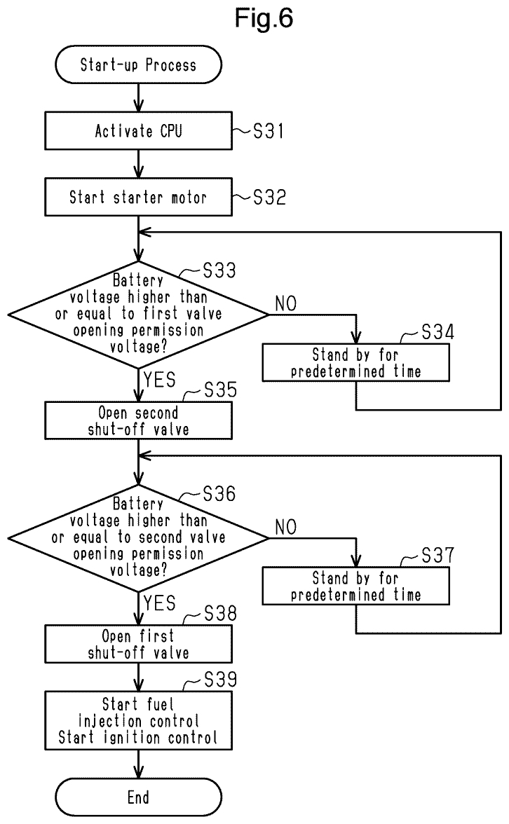

Next, a third embodiment of the engine controller will be described with reference to FIGS. 5 and 6.

In the third embodiment, the controller 100 is connected to a voltage sensor that detects the voltage of the battery 200. The voltage sensor outputs a detection signal regarding the detected voltage of the battery 200 to the controller 100.

### The Start-Up Processing in the Third Embodiment

As shown in FIG. 6, in the start-up process, the controller 100 starts the CPU 110 in the same manner as in the first embodiment (step S31), and starts the operation of the starter motor 300 (step S32).

Thereafter, the controller 100 determines whether or not the voltage of the battery 200 is equal to or higher than the first valve opening permission voltage (step S33). In the present embodiment, the first valve opening permission voltage is a voltage required for opening the second shut-off valve 20. If the voltage is less than the first valve opening permission voltage (step S33: NO), the controller 100 waits for a certain period of time (step S34), and then returns to the process of step S33. Thus, the controller 100 waits until the voltage of the battery 200 becomes equal to or higher than the first valve opening permission voltage. On the other hand, when the voltage is equal to or higher than the first valve opening permission voltage (step S33: YES), the controller 100 opens the second shut-off valve 20 (step S35).

Subsequently, the controller 100 determines whether or not the voltage of the battery 200 is equal to or higher than the second valve opening permission voltage (step S36). In the present embodiment, the second valve opening permission voltage is a voltage required for opening the first shut-off valve 19. In a case where the voltage is lower than the second valve opening permission voltage (step S36: NO), the controller 100 waits for a predetermined time (step S37) and then returns to the process of step S36. Thus, the controller 100 waits until the voltage of the battery 200 becomes equal to or higher than the second valve opening permission voltage. On the other hand, when the voltage is equal to or higher than the second valve opening permission voltage (step S36: YES), the controller 100 opens the first shut-off valve 19 (step S38). Thereafter, the controller 100 starts the fuel injection control and the ignition control (step S39), and ends the start-up process.

As described above, in the present embodiment, the satisfaction of the valve opening condition corresponds to a state in which the voltage of the battery 200 is equal to or higher than the valve opening permission voltage. That is, the controller 100 opens the first shut-off valve 19 and the second shut-off valve 20 when a valve opening condition in which the voltage of the battery 200 exceeds a predetermined value is satisfied. In the present embodiment, the first valve opening permission voltage corresponds to a first value required to open the second shut-off valve 20, and the second valve opening permission voltage corresponds to a second value required to open the first shut-off valve 19.

### Operation of the Third Embodiment

As shown in part (a) of FIG. 5, when the ignition switch 400 is turned on, the CPU 110 is activated (point in time t11) in the above-described start-up process, as in the cases of the first and second embodiments. As shown in part (b) of FIG. 5, after the CPU 110 is activated, the operation of the starter motor 300 is subsequently started (point in time t12). As a result, as shown in part (e) of FIG. 5, the engine speed starts to increase. At this time, as shown in part (f) of FIG. 5, the voltage of the battery 200 decreases due to the start of the operation of the starter motor 300. As shown in part (d) of FIG. 5, the second shut-off valve 20 is opened when the voltage of the battery 200 reaches or exceeds the first valve opening permission voltage (point in time t13). Also, as shown in part (c) of FIG. 5, the first shut-off valve 19 is opened when the voltage of the battery 200 reaches or exceeds the second valve opening permission voltage (point in time t14). During this period, as shown in part (f) of FIG. 5, the voltage of the battery 200 recovers over time. Accordingly, during the start-up process, the first shut-off valve 19 and the second shut-off valve 20 are sequentially opened in accordance with recovery of the voltage of the battery 200, which was initially reduced due to the initiation of operation of the starter motor 300.

### Advantages of the Third Embodiment

(3-1) In the start-up process of the present embodiment, the first shut-off valve 19 and the second shut-off valve 20 are respectively opened when the voltage of the battery 200 reaches or exceeds corresponding one of the first and second valve opening permission voltages. This configuration suppresses failure to open the first shut-off valve 19 and the second shut-off valve 20 due to low voltage of the battery 200. This reduces the likelihood of start-up failure.

(3-2) The voltage required to open the first shut-off valve 19 is higher than the voltage required to open the second shut-off valve 20. The present embodiment prioritizes opening of the second shut-off valve 20, which requires the lower voltage, thereby enabling rapid opening of both the first shut-off valve 19 and the second shut-off valve 20.

### Modifications

The above-described embodiments may be modified as follows. The above-described embodiments and the following modifications can be combined as long as the combined modifications remain technically consistent with each other.

In the start-up process, the controller 100 may simultaneously open the first shut-off valve 19 and the second shut-off valve 20 when the voltage of the battery 200 becomes equal to or higher than a predetermined valve opening permission voltage. In this case, the valve opening permission voltage may be set to a voltage higher than both a first valve opening permission voltage at the time when the second shut-off valve 20 is opened alone and a second valve opening permission voltage at the time when the first shut-off valve 19 is opened alone.

In the start-up process, the controller 100 may perform control to open the shut-off valve 19, 20 on the condition that a specified valve opening standby time has elapsed from the start of operation of the starter motor 300 and the voltage of the battery 200 has become equal to or higher than a predetermined valve opening permission voltage. That is, the valve opening condition for opening the shut-off valve 19, 20 may include both a condition that a predetermined waiting time has elapsed from the start of the operation of the starter motor 300 and a condition that the voltage of the battery 200 has exceeded a predetermined value.

In a case where the first shut-off valve 19 and the second shut-off valve 20 are opened at different timings, the controller 100 may open the first shut-off valve 19 before the second shut-off valve 20. Thus, the fuel can be quickly supplied from the fuel tank 12 to the fuel pipe 17.

The method of determining the valve opening standby time may be changed as appropriate. For example, the valve opening standby time may be determined based on a condition different from the passage fuel temperature, the coolant temperature, and the outside air temperature, instead of or in addition to the passage fuel temperature, the coolant temperature, and the outside air temperature. For example, the valve opening standby time may be determined according to the passage fuel pressure that is the pressure of the fuel in the fuel passage 14 detected by the pressure sensor 23, 24. In this case, when the passage fuel pressure is low, the controller 100 may determine a shorter time as the valve opening standby time than when the passage fuel pressure is high. At this time, when the passage fuel pressure is low, it is considered that the amount of fuel remaining in the fuel passage 14 is smaller than when the passage fuel pressure is high. Therefore, when the passage fuel pressure is low, the controller 100 determines a shorter time as the valve opening standby time than when the passage fuel pressure is high. Thus, when the amount of fuel remaining in the fuel passage 14 is small, it is possible to quickly supply fuel from the fuel tank 12 to the fuel passage 14. Further, the valve opening standby time does not necessarily need to be determined by the controller 100, and may be a predetermined fixed time.

The engine 10 may include only one of the first shut-off valve 19 and the second shut-off valve 20.

The trigger for starting the operation of the starter motor 300 may be changed as appropriate. For example, after the CPU 110 is started in response to the turn-on operation of the ignition switch 400, the operation of the starter motor 300 may be started in response to the operation of a specified operating means. Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An engine controller for controlling an engine including a shut-off valve provided in a fuel passage connecting a fuel tank to a fuel injection valve, a starter motor used to start the engine, and a battery for supplying electric power to the shut-off valve and the starter motor, the engine controller comprising:
processing circuitry configured to execute an operation control of the starter motor and an opening-closing control of the shut-off valve,
wherein, the processing circuitry is configured to execute a control for opening the shut-off valve when a predetermined valve opening condition is satisfied after a start of operation of the starter motor.

2. The engine controller according to claim 1, wherein the valve opening condition is that a predetermined standby time has elapsed since the operation of the starter motor is started.

3. The engine controller according to claim 2, wherein
the controller is employed in an engine that includes a first shut-off valve provided in the fuel passage and a second shut-off valve disposed closer to the fuel injection valve in the fuel passage than the first shut-off valve is, and
the processing circuitry is configured to execute a control to
open the second shut-off valve when a first standby time has elapsed after starting the operation of the starter motor, and
after the elapse of the first standby time, open the first shut-off valve when a second standby time has elapsed.

4. The engine controller according to claim 1, wherein the valve opening condition is that a voltage of the battery exceeds a predetermined value.

5. The engine controller according to claim 4, wherein
the controller is employed in an engine that includes a first shut-off valve provided in the fuel passage and a second shut-off valve disposed closer to the fuel injection valve in the fuel passage than the first shut-off valve is, and
the processing circuitry is configured to execute a control to
open the second shut-off valve when the voltage of the battery exceeds a first value, and
open the first shut-off valve when the voltage of the battery exceeds a second value, the second value being higher than the first value.
